(19) United States
(12) Patent Application Publication
(10) Pub. No.: US 2016/0216891 A1
(43) Pub. Date: Jul. 28, 2016

(54) DYNAMIC STORAGE FABRIC

(71) Applicant: CISCO TECHNOLOGY, INC., San Jose, CA (US)

(72) Inventors: Joseph Bradley Bester, Alpharetta, GA (US); Dana Blair, Alpharetta, GA (US)

(73) Assignee: CISCO TECHNOLOGY, INC., San Jose, CA (US)

(21) Appl. No.: 14/606,649

(22) Filed: Jan. 27, 2015

(51) Int. Cl. G06F 3/06

(52) U.S. Cl. CPC G06F 3/0604; G06F 3/064; G06F 3/0685

(57) ABSTRACT

In one embodiment, a method includes receiving at a controller, storage information from a plurality of storage devices over a dynamic storage fabric, the storage devices in communication with the dynamic storage fabric through a plurality of switches in communication with a plurality of client devices, storing the storage information in a table at the controller, and transmitting entries from the table to the switches for use in processing write and read requests from the client devices. A method at a switch and an apparatus is also disclosed herein.

### TECHNICAL FIELD

The present disclosure relates generally to communication networks, and more particularly, to a distributed storage system.

### BACKGROUND

Network caching is used to keep frequently accessed information in a location close to a requester of the information. Application performance may be reduced when storage access requests are queued and eventually serviced in a distributed storage system such as SAN (Storage Area Network) or NAS (Network Attached Storage). The latency involved in retrieving each block of data includes network induced latency and the time the system that stores the data takes to put the data on the network.

### BRIEF DESCRIPTION OF THE DRAWINGS

FIG. 1 illustrates an example of a network in which embodiments described herein may be implemented.

FIG. 2 depicts an example of a network device useful in implementing embodiments described herein.

FIG. 3 is a flowchart illustrating an overview of a process at a controller in a dynamic storage fabric, in accordance with one embodiment.

FIG. 4 is a flowchart illustrating an overview of a process at a switch in the dynamic storage fabric, in accordance with one embodiment.

FIG. 5 illustrates an example of operation at the controller in the dynamic storage fabric, in accordance with one embodiment.

FIG. 6 illustrates an example of operation at the switch in the dynamic storage fabric during a write operation, in accordance with one embodiment.

FIG. 7 illustrates an example of operation at the switch in the dynamic storage fabric during a read operation, in accordance with one embodiment.

FIG. 8 illustrates an example of a network with a plurality of clients in communication with the dynamic storage fabric.

Corresponding reference characters indicate corresponding parts throughout the several views of the drawings.

### DESCRIPTION OF EXAMPLE EMBODIMENTS

### Overview

In one embodiment, a method generally comprises receiving at a controller, storage information from a plurality of storage devices over a dynamic storage fabric, the storage devices in communication with the dynamic storage fabric through a plurality of switches in communication with a plurality of client devices, storing the storage information in a table at the controller, and transmitting entries from the table to the switches for use in processing write and read requests from the client devices.

In another embodiment, a method generally comprises receiving from a controller, storage information at a switch in a dynamic storage fabric, the switch in communication with a plurality of client devices and storage devices, receiving at the switch, a write request from one of the client devices, forwarding the write request from the switch to one of the storage devices based on storage information at the switch, and receiving at the switch, updates to storage information from the controller based on write and read requests in the dynamic storage fabric.

In yet another embodiment, an apparatus generally comprises a processor for processing in a dynamic storage fabric, storage information from a controller and a write request from a client device, and forwarding the write request to a storage device selected based on the storage information, and memory for storing the storage information and updates from the controller based on write and read requests in the dynamic storage fabric.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

The embodiments described herein provide a Dynamic Storage Fabric (DSF) comprising separate control and data planes that can service storage write and read requests between client devices and storage devices attached to the fabric via network devices such as switches. The switches may include additional memory so that they can operate as a local data cache to service the clients. As described in detail below, a DSF controller has a holistic view of the DSF and may use algorithms to pre-fetch data from the storage targets and store it adjacent to requesting clients in a fast cache memory at the DSF switch. This allows the DSF switch to service the data read to the client faster, while the DSF balances the load across multiple storage targets to provide less bursty and more predictable read requests. In certain embodiments, analysis in the controller may be used to balance the performance need of a client against its priority among other clients and the overall performance of the distributed storage system. In one or more embodiments the distributed storage system may comprise a Software Defined Network (SDN) enabled fabric that separates control and data plane processes for the purpose of writing and reading data between clients and storage targets.

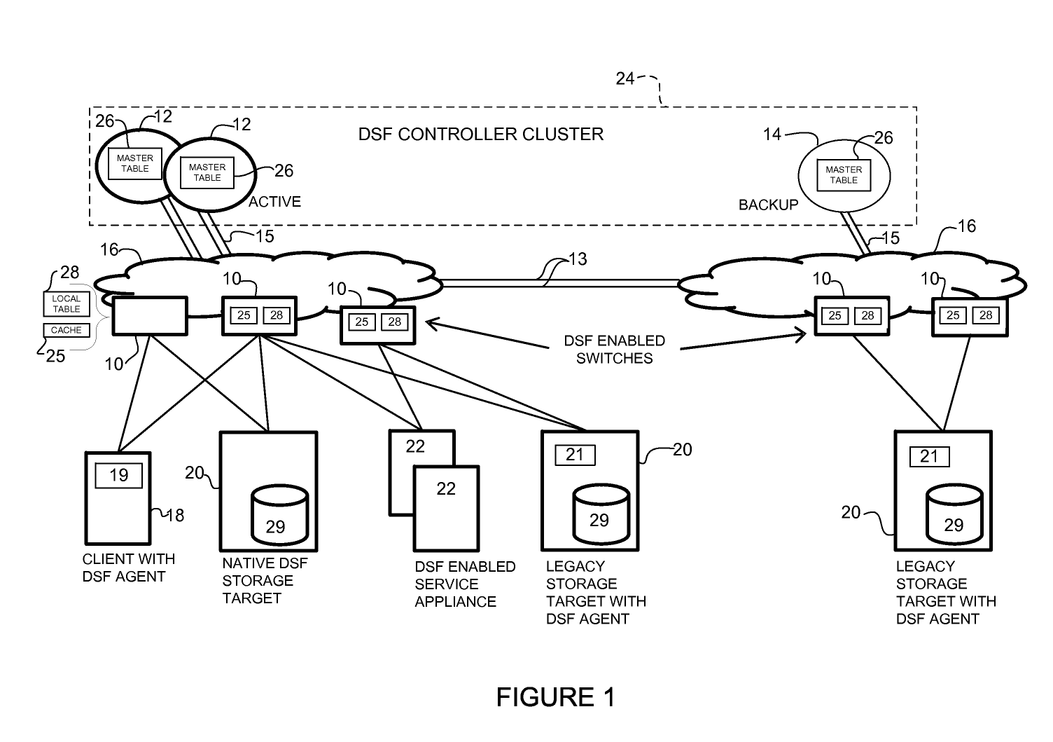

Referring now to the drawings, and first to FIG. 1, an example of a network in which embodiments described herein may be implemented is shown. The embodiments operate in the context of a data communication network including multiple network devices. For simplification, only a small number of network devices are shown. The network may include any number of network devices in communication via any number of nodes (e.g., routers, switches, gateways, or other network devices), which facilitate passage of data within the dynamic storage fabric.

In the example shown in FIG. 1, a distributed storage system includes DSF switches 10 in communication with one or more controllers (e.g., active controllers 12, backup controller 14) via networks 16. The switches 10 are in communication with one or more client devices 18, storage devices (targets) 20, and service appliances 22. The client 18 and storage target 20 may include an agent 19, 21, respectively. In the example shown in FIG. 1, the dynamic storage fabric comprises the switches 10, controllers 12, 14, and agents 19, 21 on the clients 18 and storage targets 20, or native storage targets. As described below, the controllers 12, 14 form a DSF control plane and a separate DSF data plane is defined by the switches 10.

The clients 18 (end users, stations) write and read data from the distributed storage targets 20 attached to the same or other DSF switches 10 in the fabric. In a pure DSF mode, the client 20 may comprise a thin agent 19 for telemetry and reporting. In a hybrid DSF, the agent 19 may provide encapsulation, decapsulation, telemetry, reporting, legacy storage protocol spoofing to operating system, or any combination of these or other functions.

The storage device (target) 20 includes storage 29, which may comprise any type or amount of memory. As shown in the example of FIG. 1, the storage target may be a legacy storage device with a DSF agent 21 or a native DSF storage device. In a pure DSF system, the legacy target agent 21 may provide telemetry, reporting, legacy storage protocol spoofing to operating system, or any combination of these or other functions. In a hybrid DSF, the legacy target agent 21 may provide encapsulation, decapsulation, telemetry, reporting, legacy storage protocol spoofing to operating system, or any combination of these or other functions. The native DSF target provides a pure/hybrid native DSF storage target and includes an interface to the DSF (not shown).

The distributed storage system may also include one or more DSF enabled service appliances 22. The service appliance 22 may provide a pure/hybrid appliance to which data plane traffic can be redirected for various functions, including, for example, legacy protocol gateway (e.g., NFS (Network File System)) to remove from agent 19, 21 or where an agent cannot be installed on the client 18 or legacy storage target 20. The DSF enabled service appliance 22 may also operate as a de-duplication service appliance, encryption service appliance, security service appliance, or provide other service functions.

As previously noted, the DSF control plane includes the controllers 12, 14. As shown in the example of FIG. 1, the DSF controllers 12, 14 may be part of a DSF controller cluster 24. The DSF controller cluster 24 may include any number of active controllers 12 and may also include one or more backup controllers 14. The backup controller 14 may be located remote from the active controllers 12 (e.g., at a remote data center). The data centers may communicate via any number of communication links (e.g., links 13 between networks 16). The backup controller 14 may be located at the remote site with replicated information from the primary site controller 12 to allow for remote site recovery in case of DCI (Data Center Interconnect) failure, for example.

The controllers 12, 14 may be physical devices (e.g., server, appliance) or may be a virtual device residing on a server or other network device. The controllers 12, 14 may communicate with the switches 10 via any number of communication links 15, using any type of suitable communication protocol.

The controllers have a holistic view of the DSF and may centrally track read and write operations in the DSF. In certain embodiments, the control plane maintains a master table 26 at the controllers 12, 14. The master table 26 may include, for example, network device addresses, storage allocation, or any other storage information. The controller 12 may maintain and push policies, hosts user interfaces, or other information to local tables 28 at the switches 10. The master table 26 at the backup controller 14 may include a copy of the entire table stored at the active controller 12 or contain only a portion of the entries maintained at the active controller.

As previously noted, the DSF data plane includes the DSF enabled switches 10. The DSF switches 10 manage the replication and routing of data through the fabric to the various targets 20. The data plane may be, for example, a pure DSF data plane providing pure DSF encapsulation/decapsulation, routing, service redirection, replication, etc. The DSF data plane may also be a hybrid data plane in which the main data plane is used for routing, service redirection, replication, etc. The switches 10 may be, for example, Top of Rack (ToR) switches, access switches, or any other network device operable to perform forwarding functions. As shown in FIG. 1, the clients 18 and storage targets 20 are attached to the fabric via the switches 10. Each switch 10 may be adjacent to any number of clients 18 and in communication with any number of storage targets 20.

As described in detail below, each of the DSF switches 10 include local table 28, which is populated by entries received from the controller 12. The switch 10 uses storage information from its local table 28 in processing write and read requests in the DSF. For example, the switch 10 may check its local table 28 to identify the storage target (or targets) 20 to which a write request should be transmitted, or identify a location of data for a read request. The switch 10 may also query the fabric (e.g., transmit request to other switches) to identify a location of the data. The switches 10 may communicate with one another through the DSF fabric using any suitable communication protocol.

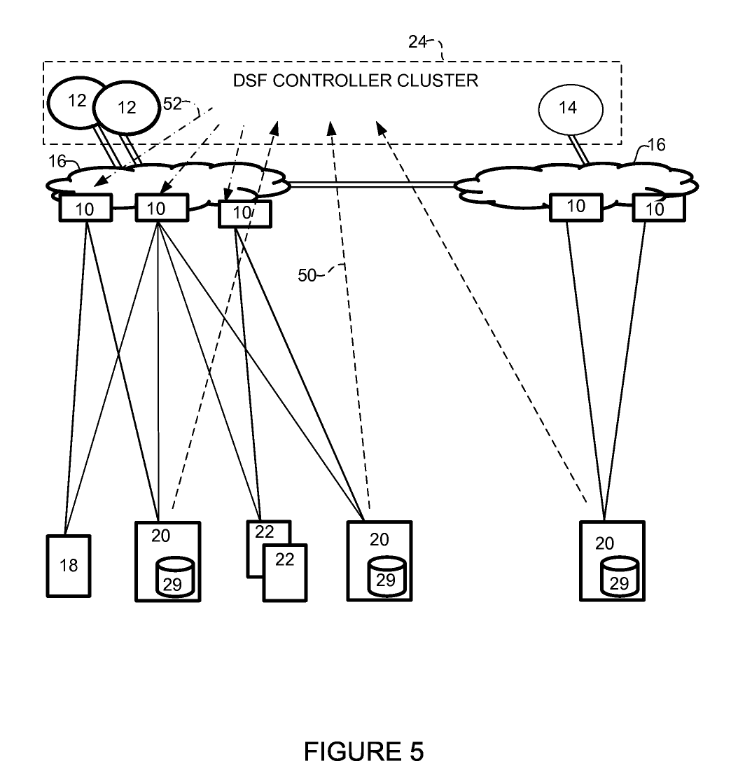

Details of operation at the controller 12 and switch 10 during building of the master table 26 and local table 28 and write and read requests are described below with respect to examples shown in FIGS. 5, 6, and 7.

In certain embodiments, the switches 10 include memory 25 (referred to herein as fast cache), which is allocated in the DSF switches to provide closer and faster (due to the smaller amount of data stored) cache of data for the clients 18. As described in detail below, when the clients 18 write through the fabric to storage targets 20 attached to the fabric, the switch 10 may copy data in flight to the cache 25. On subsequent reads, the request may be routed to the local cache 25 at the switch 10 rather than the remote storage target 20.

In one example, the switches 10 may reserve memory for a local fast cache of recently written blocks of data, which are positioned as data is written. The controller 12 may also monitor read requests and compare them to the original written master table order to predictively fetch and place data blocks in the cache 25 of the switch 10. If copies exist on local targets 20, the controller 12 may order the agents to copy blocks in a round-robin or other load balancing algorithm based on the target utilization and performance characteristics to place the data blocks in the switch DSF fast cache closest to the requesting client 18. This may reduce latency from the perception of the client 18 and allow a more efficient and predictable traffic pattern on the fabric and utilization of the storage targets 20.

As previously described, the controller 12 has a holistic view of the DSF. In order to maintain status in the master table 26, the controller 12 receives information when write or read requests are transmitted to the switch 10. For example, in one or more embodiments, the DSF controller 12 receives acknowledgements when data is written to the storage target 20 to maintain data locations in the master table 26. When the client 18 writes to the storage target 20 as part of an application process, multiple blocks may be written. When the client 18 reads data, it may be requested in blocks to allow the data to be processed by the client. These reads may be bursty in nature depending on the ability of the client to buffer the data.

Contiguous blocks will be in the master table 26 sequentially since they were written and acknowledged sequentially across the DSF when originally written. The controller 12 may use this information to predictively request that blocks are copied from any storage targets 20 in the fabric with copies of those blocks to the local fast cache 25 of the switch 10 closest to the requesting client 18 of the first block of data. Blocks of data may then be serviced locally in the switch 10 directly to the client 18, rather than traversing the fabric, and any delay requested from the client as it services its local buffer can still be used in the fabric to preposition this data.

In certain embodiments, for larger groups of blocks, analytical analysis may be performed in the controller 12 to include the location of the blocks in the storage targets 20, the performance of the targets, the location and priority of the client 18, and the performance of the fabric to determine the optimum way to copy blocks of data to the fast cache 25 for both the client 18 and the targets 20 and fabric. This can balance the needs of the requesting client 18 with the needs of other clients concurrently requesting the same or different data.

It is to be understood that the network shown in FIG. 1 is only an example and that the embodiments described herein may be implemented in networks having different network devices or topologies, or using different protocols, without departing from the scope of the embodiments. For example, the fabric may service various file servers or file system protocols, such as NFS (Network File System), or HDFS (Hadoop Distributed File System), or be used with other protocols (e.g., iSCSI (Internet Small Computer System Interface), FC (Fibre Channel), FCoE (Fibre Channel over Ethernet)).

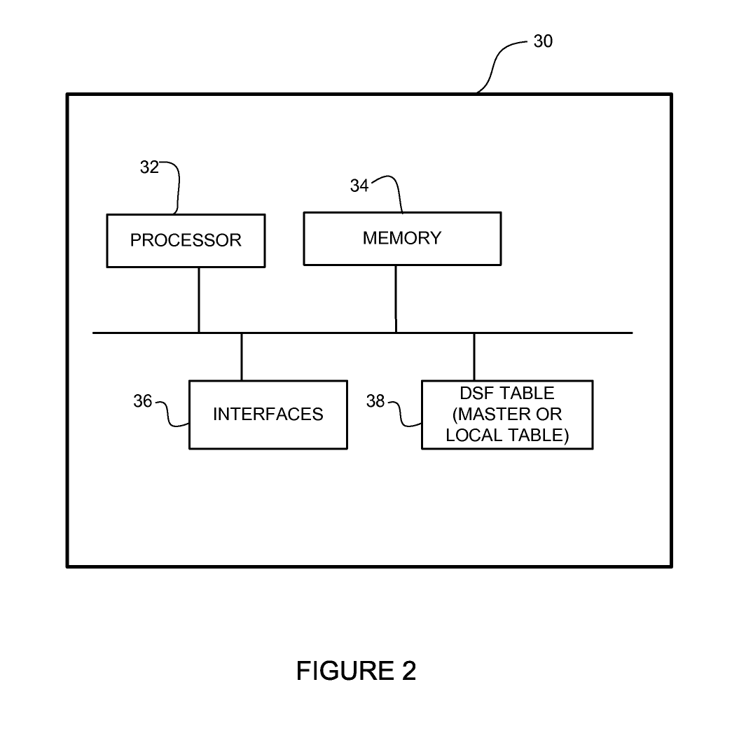

FIG. 2 illustrates an example of a network device 30 (e.g., switch 10, controller 12) that may be used to implement the embodiments described herein. In one embodiment, the network device 30 is a programmable machine that may be implemented in hardware, software, or any combination thereof. The network device 30 includes one or more processor 32, memory 34, network interfaces 36, and DSF table 38 (e.g., master table 26, local table 28 in FIG. 1).

Memory 34 may be a volatile memory or non-volatile storage, which stores various applications, operating systems, modules, and data for execution and use by the processor 32. For example, memory 34 may include the DSF table 38, which may be any type of data structure. For a DSF switch 10, memory 34 may also include the fast cache 25 (shown in FIG. 1). The network device 30 may include any number of memory components.

Logic may be encoded in one or more tangible media for execution by the processor 32. For example, the processor 32 may execute codes stored in a computer-readable medium such as memory 34. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium. The computer-readable medium may be a non-transitory computer-readable storage medium, for example.

The network interfaces 36 may comprise any number of interfaces (linecards, ports) for receiving data or transmitting data to other devices. The network interfaces 36 may include, for example, an Ethernet interface for connection to a computer or network. The network interfaces 36 may be configured to transmit or receive data using a variety of different communication protocols. The interfaces 36 may include mechanical, electrical, and signaling circuitry for communicating data over physical links coupled to the network.

It is to be understood that the network device 30 shown in FIG. 2 and described above is only an example and that different configurations of network devices may be used. The network device 30 may further include any suitable combination of hardware, software, algorithms, processors, devices, modules, components, or elements operable to facilitate the capabilities described herein. For example, one or more components may be implemented in hardware (e.g., ASIC (Application Specific Integrated Circuit)). The DSF may leverage ASIC capabilities that will naturally scale as the fabric grows by adding additional fabric components with these ASICs.

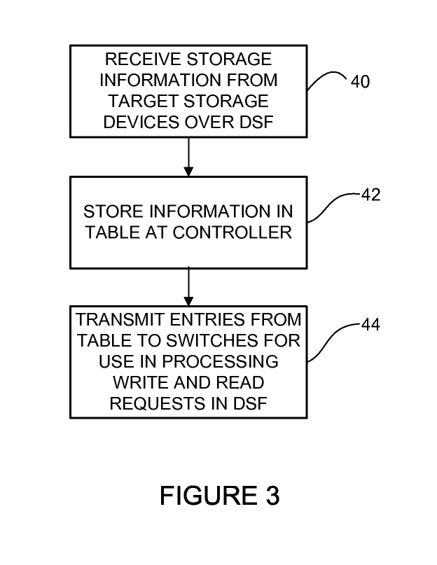

FIG. 3 is a flowchart illustrating an overview of a process at the controller 12 in the DSF, in accordance with one embodiment. At step 40, the controller 12 receives storage information from the storage devices 20 (storage agents, DSF targets) (FIGS. 1 and 3). For example, the storage targets 20 may transmit storage information in a registration request to the controller 12. The storage information may include, for example, capacity and capability information (e.g., IOPs (Input/Output Operations Per Second), location), local disk and node addresses, or any combination of these or other parameters. The controller 12 builds a master table 26 and stores the information received from the storage target 20 in the table (step 42). The table 26 may contain, for example, storage and current state (e.g., available, used, offline), and characteristics based on target capabilities. The controller 12 transmits storage information entries to each switch 10 for storage in the local table 28 at the switch (step 44). The table entries may include, for example, block/file handle DSF address, distance, type, or any combination of these or other parameters. The switch 10 uses this information to process write and read requests in the DSF. As described below, the master table 26 may be updated as conditions change. These updates may be transmitted to the switch 10 and applied to the local table 28.

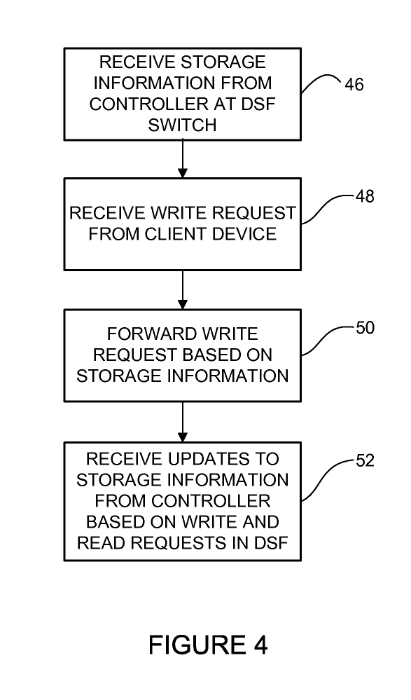

FIG. 4 is a flowchart illustrating an overview of a process at switch 10 in the DSF, in accordance with one embodiment. At step 46, the switch 10 receives storage information from the controller 12 and stores entries in its local table 28. The switch 10 receives a write request from one of the client devices (step 48). The switch 10 forwards the write request to one of the storage devices 20 selected based on an entry in its local table (step 50). For example, the switch 10 may forward a write request to one of the storage targets 20 based on distance and based on policy, the switch may also replicate the request and forward to other switches. The storage devices 20 write the received data to their disks and may send an acknowledgement to the controller 12, so that the controller can update its master table 26. The switch 10 may direct a read request to one of the storage targets 20 based on information in the local table 28. The switch may also query the fabric. For example, the switch 10 may broadcast or multicast a request to other switches in the DSF to find a location of the data. The target 20 may report the read to the controller 12 for use in analytics or monitoring. The switch 10 receives updates to its local table 28 from the controller 12 based on write and read requests in the DSF (step 52).

It is to be understood that the flowcharts shown in FIGS. 3 and 4 are only examples and that steps may be added, removed, or modified, without departing from the scope of the embodiments.

FIG. 5 illustrates an example of operation at the controller 12 in the dynamic storage fabric shown in FIG. 1. The storage targets 20 transmit registration requests 50 to the controller 12 with available capacity and capabilities, local disk addressing (e.g., blocks or file handles), and node address (e.g., IP (Internet Protocol) address, MAC (Media Access Control) address, WWNN (World Wide Node Name)/WWPN (World Wide Port Name)).

The controller 12 builds the master table of available storage and current state and characteristics based on target capabilities. The controller cluster 24 pre-positions a number of unique storage information entries based on policy to each client-adjacent DSF switch table (indicated at arrows 52). Table entries in the local table 28 may include, for example, block/file handle DSF address, distance, type (e.g., performance, tier, cost).

As conditions change (e.g., heavy utilization of target input/output, failed disks) updates are sent to the controller 12 to update the master table 26 (FIGS. 1 and 5). Central policies may also be applied to update the table (e.g., via human intervention, north bound API (application programming interface) from an external system).

Various types of policies may be set in the distributed storage system. In one example, for a gold client, all writes are to three unique targets 20 with two acknowledgements received from targets prior to transmitting an acknowledgement to the client 18, with one target one hop away and one target at a remote site. Acknowledgement must be received within a set time (e.g., 100 microseconds). For a silver client, the client 18 writes to two unique targets 20, one local, one at remote site. Acknowledgment must be received within less than 500 microseconds. For a bronze client, the client 18 writes to two unique targets 20 based on storage cost. One acknowledgement must be received in less than two milliseconds. It is to be understood that these are only examples and that other polies may be defined without departing from the scope of the embodiments.

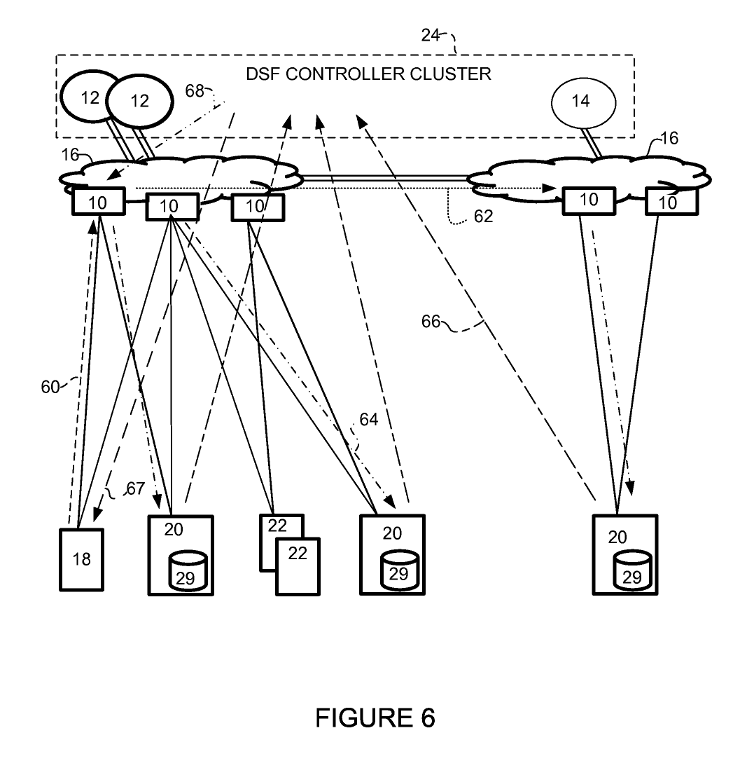

FIG. 6 illustrates an example of a write request in the DSF, in accordance with one embodiment. The client 18 sends a write request 60 (e.g., via DSF client agent) to the switch 10. The switch 10 checks table policies and replicates the packet as required, forwarding to other DSF switches via the fabric (indicated at arrow 62). Remote storage targets 20 receive the transmitted data (64), write the received data to their disks, and signal DSF target agents to send an acknowledgement (66).

In one example, each target 20 sends an acknowledgement to the controller 12 when data is successfully written at the target. The controller 12 updates its master table 26 and when the number and type of writes meet policy requirements, an acknowledgement is sent to the client 18 (indicated at arrow 67) (Figures and 1 and 6). A more specific table update may be sent to the switch 10, and the controller 12 may provide a new block of storage to the switch for it to update its local available storage table (68). The switch 10 may move the written block to its read table and age out the oldest entry if the table is full.

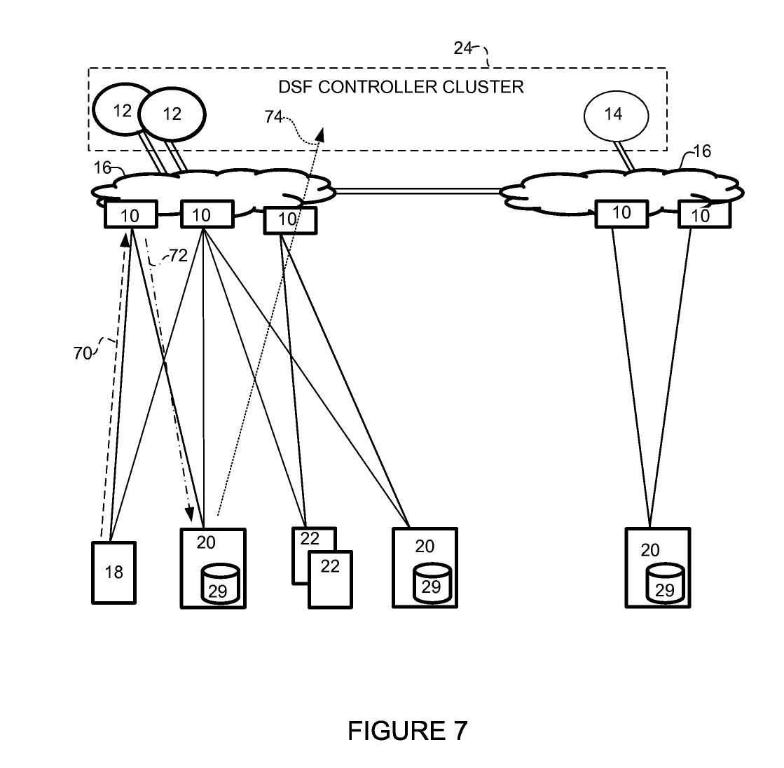

FIG. 7 illustrates a read operation in the DSF, in accordance with one embodiment. The client device 18 transmits a read request 70 to adjacent switch 10. The switch 10 redirects the packet based on shortest path and current fabric characteristics and forwards the request to one of the storage devices 20 (indicated at arrow 72). A routing algorithm or controller analytics may take extended metrics into consideration (e.g., least loaded target, avoid read from flash, only read from local targets, round robin read of each block of data from different targets, read first from native DSF targets, based on configured client class, etc.). The storage targets 20 report the read to the controller 12 for use in analytics and monitoring (74).

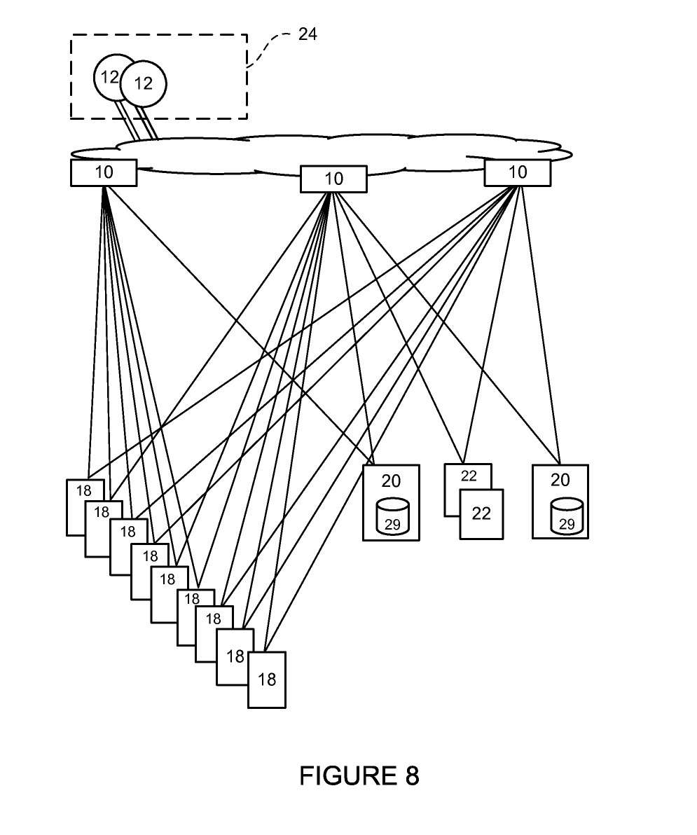

FIG. 8 illustrates an example of replication for a simultaneous read request for the same target block from multiple clients 18 in the fabric. The DSF can replicate the data in flight from the target 20 to the client 18 at the switch 10, and switch that block to another target to be written as a copy. Once the replicated blocks are written, the second target agent can update the controller 12, which in turn updates the switch read tables. The more clients 18 requesting read access will result in more automatic fabric duplications to load balance the read requests against targets 20 and potentially disks or other devices in the targets without direct controller initiation of the copies. Once the “storm” is over, the blocks can be marked as available to be overwritten by future writes and the switch read table entries can be purged. Clients 18 in the fabric may also receive directly replicated copies of the data from the switch 10, which may be served from in switch memory.

In certain embodiments, the controller 12 may provide one or more of the following expanded functions. In one or more embodiments, the controller 12 may signal target agents to replicate traffic for recovery, stale data archival (tiering), etc. The controllers 12 may also allow the insertion of service nodes to provide extended storage services such as encryption, data deduplication, or other services, by registering those nodes and providing redirection table entries to the switches 10. In one or more embodiments, the controller 12 may provide a north bound API for orchestration/monitoring.

In certain embodiments, analytics may be used to determine optimum placement of data and number of copies. For example, archiving of stale data, spawned copies to handle boot storms or other read spikes, expulsion and collapse of copies for data analysis processing, optimization of flash reads and writes, dynamic allocation of centralized RAM based shared cache, etc. The controller 12 may also provide integrated HA (High Availability)/remote replication.

In one or more embodiments, a first or second write request may be acknowledged back to the client device 18 so that processing will not be slowed. This may be performed based on policy, for example. Subsequent writes may be monitored by the controller 12 until completed. In the event a tertiary write is not completed, the controller 12 may initiate a direct target to target write and may even change the destination target as needed to meet the policy for HA copies.

The controller 12 may also transmit a replication command to a storage target 20 to provide archival and tiering. For example, target agents may provide storage cost, utilization, and read statistics to the controller 12. Policy may dictate archival and tiering policies. The controller 12 may move stale data from expensive to inexpensive hardware or reduce the number of copies of stale data as dictated by a policy by initiating a copy or move from a target agent. Examples of policies include flash restricted to one week old data before being copied to legacy disk, or data not accessed for three months can only exist in two copies (one at each site) on DAS (Direct Attached Storage) based storage.

As can be observed from the foregoing, the embodiments described herein are particularly advantageous in that the system provides a holistic view of the fabric and storage targets. The holistic view of the distributed storage system includes temporal data around writes and instantaneous data around current system component performance to make more informed decisions on how best to fill a cache to the benefit of not just the client, but also the total system. Also, since the memory in the switch is adjacent to multiple clients, it represents a better utilization of the memory through oversubscription opportunities. In one or more embodiments, there is no need for allocation of memory in the individual clients. Load balance or predictive queueing of data may be performed based on the topology of the fabric, performance characteristics or load of the fabric, or performance or utilization of the storage targets. The dynamic storage fabric approach described above may provide increased scalability and lower latency as the fabric components are physically closer to the clients and targets.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
receiving at a controller, storage information from a plurality of storage devices over a dynamic storage fabric, said plurality of storage devices in communication with the dynamic storage fabric through a plurality of switches in communication with a plurality of client devices;
storing said storage information in a table at the controller; and
transmitting entries from the table to said plurality of switches for use in processing write and read requests from the client devices.

2. The method of claim 1 further comprising receiving input based on said write and read requests in the dynamic storage fabric and updating the table at the controller and said entries at the switches.

3. The method of claim 1 wherein the controller belongs to a controller cluster.

4. The method of claim 3 wherein the controller cluster comprises a backup controller.

5. The method of claim 1 wherein said storage information comprises capacity and capability of the storage devices.

6. The method of claim 1 wherein said table entries comprise address and distance information for the storage devices.

7. The method of claim 1 further comprising receiving an acknowledgment from one or more of the storage devices after data is written to the storage device.

8. The method of claim 7 further comprising transmitting an acknowledgment to the client device after a policy is met for a write request.

9. The method of claim 1 further comprising receiving a report from one of the storage devices following a read request.

10. The method of claim 1 further comprising identifying an optimum placement for data in a write request.

11. The method of claim 1 wherein said table entries are transmitted to said plurality of switches based on policies at the controller.

12. A method comprising:
receiving from a controller, storage information at a switch in a dynamic storage fabric, the switch in communication with a plurality of client devices and storage devices;
receiving at the switch, a write request from one of the client devices;
forwarding said write request from the switch to one of the storage devices based on said storage information at the switch; and
receiving at the switch, updates to said storage information from the controller based on write and read requests in the dynamic storage fabric.

13. The method of claim 12 wherein said storage information comprises address and distance information for said storage devices.

14. The method of claim 12 further comprising replicating said write request and forwarding to other switches in the dynamic storage fabric based on said storage information.

15. The method of claim 12 further comprising forwarding an acknowledgment from the controller to the client device after a policy is met for said write request.

16. The method of claim 12 further comprising forwarding a report from one of the storage devices to the controller following a read request.

17. The method of claim 12 further comprising storing data in said write request at a cache at the switch and updating said storage information to identify data stored at the cache.

18. The method of claim 12 further comprising transmitting a request to other switches in the dynamic storage fabric to identify a location of data.

19. An apparatus comprising:
a processor for processing in a dynamic storage fabric, storage information from a controller and a write request from a client device, and forwarding said write request to a storage device selected based on said storage information; and
memory for storing said storage information and updates from the controller based on write and read requests in the dynamic storage fabric.

20. The apparatus of claim 19 further comprising a cache for storing data in a write request at the apparatus.
